(19) United States
(12) Patent Application Publication
(10) Pub. No.: US 2007/0153139 A1
(43) Pub. Date: Jul. 5, 2007

(54) Automotive entertainment console and dockable entertainment devices

(75) Inventors: James S. Turner, Mesa, AZ (US); Mark E. Rutledge, Murietta, CA (US); Kevin B. Goodwin, Vista, CA (US); Nguyen Vinh To, Oceanside, CA (US); Shijie Huang, Vista, CA (US); David W. Hatcher, Wildomar, CA (US)

Correspondence Address: Directed Electronics, One Viper Way, Vista, CA, 92081, US

(73) Assignee: DEI HEADQUARTERS, INC.

(21) Appl. No.: 11/322,430

(22) Filed: Dec. 30, 2005

(51) Int. Cl. H04N 5/64

(52) U.S. Cl. 348/837

(57) ABSTRACT

An entertainment console installed in a vehicle includes a docking bay for docking portable entertainment devices, such as portable media players (PMPs). A base of the console may be attached to the passenger compartment ceiling, with a display that can be flipped down from the base. A docked PMP can be played through the console. Video may be rendered on the console screen, while audio may be played through the console speaker(s), headphone jacks available on the console, or the speakers of the vehicle's audio system. Power for the PMP's operation is provided by the vehicle's electrical system. The console may also include additional docking bay(s), enabling simultaneous docking of multiple PMPs that may be played at the same time. A presentation from one PMP (e.g., a DVD player) can also be recorded on another PMP (e.g., a hard drive-based player). The screen may rotate around the vertical axis.

### FIELD OF THE INVENTION

The present invention relates generally to entertainment systems. More particularly, the invention relates to entertainment systems for use in vehicles, and to portable entertainment devices for docking to such entertainment systems.

### BACKGROUND

It is now quite common to have a video entertainment system in an automobile. Typically, a video player is mounted on the ceiling of the automobile's passenger compartment behind front seats, with a drop-down screen facing passengers seated in the rear row or rows of seats. A digital video disc (DVD) is loaded into the player and played to the passengers. To enable the passengers to listen to the DVD's audio track, the player may have a speaker and one or more receptacles for headphone jacks. The inventors here have identified a number of shortcomings with this arrangement.

One shortcoming is the need to keep media (DVDs) in the automobile. The media in the automobile may be stolen together with the automobile, or when the automobile is entrusted to a service station or a parking valet. The media may also be damaged by sun, rain (e.g., when a window is left open or in a convertible), or other elements. Moreover, many consumers install video entertainment systems in their automobiles to entertain children during trips. Thus, many, if not most, users of such systems and media are children. And little fingers are known to have destroyed many DVDs, compact discs (CDs), video and audio tapes, and other media storage devices.

Second, if the media is left in the automobile, it is not available for the consumer's use at home or elsewhere. This shortcoming is not only present for physical media storage devices, such as DVDs, but also when digital rights management software limits the number of devices authorized to play a particular presentation.

Third, a trip's length may not match the length of the presentation stored on the media. Viewing interruptions then follow. A consumer may wish to be able to continue viewing an interrupted presentation after leaving the automobile. Video players installed in vehicles, however, typically are not designed for portability. In other words, these video players generally cannot be easily removed and reinstalled, do not have autonomous power supplies, and are quite large.

Fourth, only one video presentation at one time can be played on a video player installed in an automobile. Therefore, known automobile-installed video players limit their audience to one show at a time. Although the audience is rather limited in number by the size of the rear seat(s), selection of a single video presentation can not always be achieved in harmony, especially with children of different ages in the audience.

Fifth, a fixed video player with a drop-down screen may not be ideally positioned for viewing from all rear seats and all seat positions of the automobile.

It would be desirable to provide entertainment systems that reduce or eliminate these shortcomings.

### SUMMARY

A need thus exists to reduce the necessity to store and to handle media storage devices in automobiles and other vehicles. Another need exists to reduce the necessity to keep physical media storage devices in automobiles and other vehicles. Another need exists to reduce the necessity to tie licenses (such as digital rights licenses) to entertainment systems installed in automobiles and other vehicles. Another need exists to enable a consumer to continue enjoying a media presentation after leaving an automobile or another vehicle. Another need exists to enable two or more passengers to view and/or listen to multiple media presentations on an automobile's entertainment system at the same time. Still another need exists to have an automobile-installed video player screen that can be viewed from different positions and different angles.

Embodiments of the present invention are directed to entertainment consoles that help to satisfy one or more of these needs. In an embodiment, an entertainment console for mounting in a vehicle includes a base with a docking bay configured to receive a portable entertainment device. A console connector is disposed in the docking bay. The console connector is configured to couple electrically to a complimentary portable device connector of the portable entertainment device when the portable entertainment device is disposed in the docking bay. When the console connector is coupled to the complimentary portable device connector, the console connector (1) provides electrical power from the entertainment console to the portable entertainment device, and (2) receives a video data stream from the portable entertainment device. A display renders video derived from the received video data stream. The video data stream may be an analog or a digital stream, and may but need not require additional processing before being rendered on the screen.

In selected aspects, one surface of the console's base is attached to the ceiling of the vehicle's passenger compartment, and the display is attached to the base by a hinged connector that allows the display to be flipped down from the base, for viewing by the vehicle's passengers. The hinged connector may also allow the display to be rotated relative to the vertical axis of the vehicle.

In selected aspects, the docking bay is a recess in the base of the console with a locking mechanism to hold the portable entertainment player docked in the bay.

In selected aspects, a portable entertainment device capable of docking with the entertainment console is capable of independent operation when not docked to the entertainment console.

In selected aspects, the entertainment console also includes a video processor coupled to the console connector to receive the video data stream. The video processor converts the video data stream into video signals corresponding to the video data stream, and drives the display with the video signals to cause the display to render the video corresponding to the video signals.

In selected aspects, the entertainment console is connected to the electrical system of the vehicle to receive electrical power from the electrical system of the vehicle.

In selected aspects, the entertainment console does not include an autonomous power supply. Instead, the console receives from the vehicle's electrical system the electrical power for its operation, and for operation of the players docked to it.

In selected aspects, the entertainment console receives an audio data stream from portable entertainment device when the console connector is coupled to the complimentary portable device connector of the portable entertainment device.

In selected aspects, the entertainment console also includes speakers for reproducing sound corresponding to the audio data stream received from the portable entertainment device.

In selected aspects, the entertainment console also includes headphone jacks for driving headphones with sound corresponding to the audio data stream received from the portable entertainment device. The entertainment console may further include an audio processor coupled to the console connector to receive the audio data stream, and generate the sound corresponding to the audio data stream. The audio processor may also be coupled to audio system of the vehicle to drive speakers of the audio system with the sound corresponding to the audio data stream.

In selected aspects, the entertainment console also includes a digital rights management module restricting rendering on the display of the video derived from the video data stream in accordance with intellectual property rights to content corresponding to the video (available to operator of the entertainment console, e.g., to the owner of the vehicle/console, a passenger, or owner/operator of the docked PMP).

In selected aspects, the entertainment console also has a dome light and a connector to dome light control of the vehicle, so that the dome light of the entertainment console is turned on and off in accordance with the current state of the dome light control.

In selected aspects, the entertainment console does not include a source of media presentations, such as a DVD drive.

In selected aspects, the portable entertainment device docked to the entertainment console has a DVD player, a Flash memory reader, a hard drive player, a TV tuner, and/or a satellite receiver.

In selected aspects, the entertainment console has a second docking bay, so that the console can receive two portable entertainment devices at the same time, and play content from these entertainment devices simultaneously. Video streams of the two devices may be rendered in different areas of the screen, or the console may include a second screen (for example, two screens on its screen panel) and render each video stream on a separate screen. The console may also enable recording of content from one portable entertainment player docked in one bay (e.g., a DVD player) on a second portable entertainment player docked in another bay (e.g., a hard drive player).

These and other features and aspects of the present invention will be better understood with reference to the following description, drawings, and appended claims.

### BRIEF DESCRIPTION OF THE FIGURES

FIG. 1A is a perspective view of an overhead console for mounting in a vehicle, with the screen in an open position;

FIG. 1B shows the overhead console of FIG. 1A in closed/locked position;

FIG. 1C shows a portion of a docking bay that includes a connector for coupling various portable media players to the base of the overhead console of FIGS. 1A and 1B;

FIG. 2A is a perspective view of a portable DVD player that can be docked to the overhead console of FIGS. 1A-1C;

FIG. 2B is a top view of the portable DVD player of FIG. 2A;

FIG. 3 shows the overhead console of FIGS. 1A-1C in the open position with the DVD player of FIGS. 2A/2B docked in its docking bay;

FIG. 4A shows the overhead console of FIGS. 1A-1C in the open position with a hard drive player docked in its docking bay;

FIG. 4B is a top view of the hard drive player of FIG. 4A;

FIG. 5 is a high-level electrical block diagram of an embodiment of the overhead console of FIGS. 1A-1C;

FIG. 6 is a high-level electrical block diagram of a dual-bay overhead console; and

FIGS. 7A, 7B, and 7C show an overhead entertainment console that allows its screen panel to rotate with respect to an axis that lies in the plane of the panel and is perpendicular to the axis of the hinged connector attaching the screen panel to the console's base.

### DETAILED DESCRIPTION

In this document, including the appended claims, the words “embodiment” and “variant,” as well as similar expressions, refer to particular apparatus, process, or article of manufacture, and not necessarily to the same apparatus, process, or article of manufacture. Thus, “one embodiment” or a similar expression used in one place or context may refer to a particular apparatus, process, or article of manufacture; the same or a similar expression in a different place may refer to a different apparatus, process, or article of manufacture.

The expressions “alternative embodiment,” “alternatively,” and similar phrases are used to indicate one of a number of different possible embodiments. The number of possible embodiments is not necessarily limited to two or any other quantity.

The words “couple,” “connect,” and similar expressions with their inflectional morphemes do not necessarily import an immediate or direct connection, but include within their meaning connections through mediate elements.

When used to describe an electronic entertainment device, the word “portable” refers to a device designed for portability, e.g., for being carried by a person (by hand, on the person, or in a carrying bag) in the course of the person's daily routines, such as working, walking, exercising, and engaging in other activities. A “portable media player” or “PMP” is portable storage-media based electronic device that is capable of storing and playing files in one or more media formats. The term “portable entertainment device” thus encompasses within its meaning the term “portable media player,” as well as non-media devices, such as TV tuners and satellite receivers.

The term “docking” and its various inflectional morphemes describe a state of a portable entertainment device in which the device is attached to a console and plugged into a connector of the console to receive electrical power from the console and to send to the console data streams corresponding to entertainment content available from the entertainment device. Typically, the console provides a recess (i.e., “docking bay”) with the electrical connector. A console may be mounted on the ceiling of a vehicle's passenger compartment, in the vehicle's doors, partitions, or in other places.

References to video/audio “streams” and “data streams” apply to both digital and analog streams of information.

Other definitions may be found elsewhere in this document. The scope and spirit of the invention should not necessarily be construed as strictly limited to these definitions, or to the specific examples mentioned herein.

Reference will now be made in detail to one or more embodiments of the invention that are illustrated in the accompanying drawings. Same or similar reference numerals are used in the drawings and the description to refer to the same apparatus elements and method steps. The drawings are in simplified form, not to scale, and omit apparatus elements and method steps that can be added to the described systems and methods, while including certain optional elements and steps. For purposes of convenience and clarity only, directional arrows and terms such as top, bottom, left, right, up, down, over, above, below, beneath, upper, lower, rear, and front may be used with respect to the accompanying drawings. These and similar directional terms should not necessarily be construed to limit the scope of the invention.

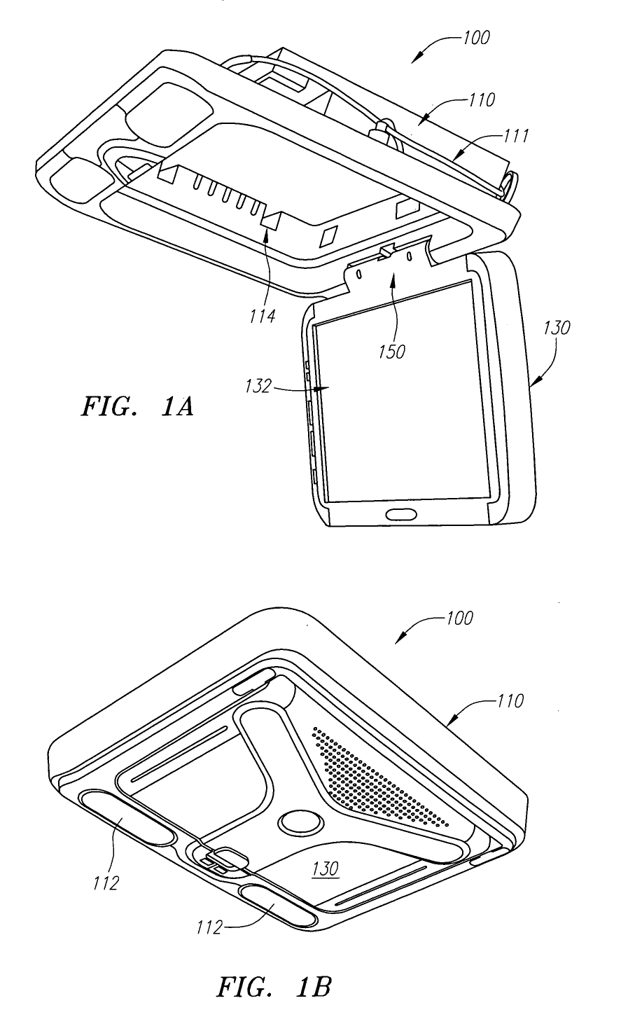

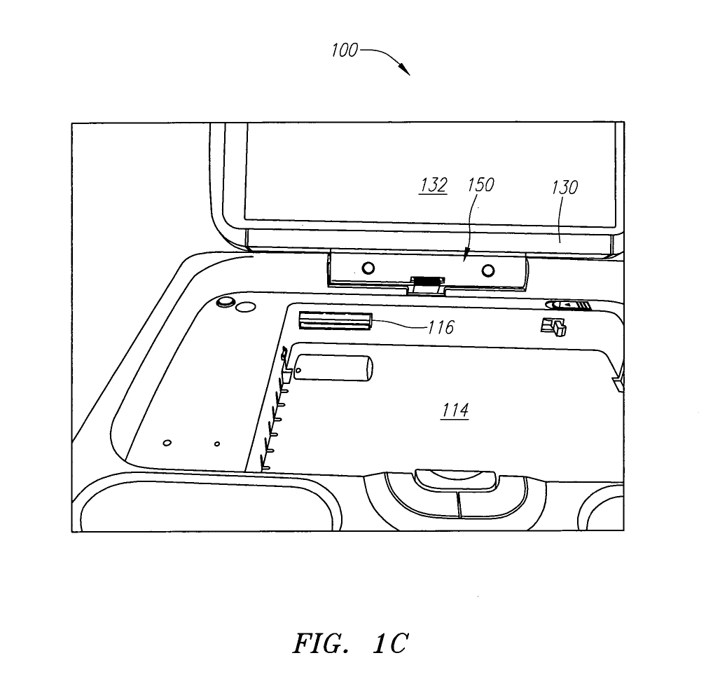

FIG. 1A is a perspective view of an automotive entertainment system overhead console 100 for mounting in a car. The overhead console includes a base 110 and a screen panel 130 attached to each other by a hinge 150. As illustrated in FIG. 1A, the overhead console 100 is in an open state, with the screen panel 130 in flipped down position. In a typical installation, back side 111 of the base 110 would be attached to a ceiling of a car's passenger compartment so that the persons in the rear seats could watch a screen 132 of the screen panel 130 when the screen panel 130 is flipped down. From this position the screen panel 130 can be pushed up, rotating it relative the axis of the hinge 150, until the screen panel 130 would lock to the base 110. FIG. 1B shows the overhead console 100 in this position. The screen 132 may be, for example, a liquid crystal display (LCD) device, black-and-white or color.

The overhead console 100 is connected to the electrical system of the car in which it is installed, so that the car's electrical system can provide electrical power for operation of the overhead console 100. The console 100 also connects to the dome light power line of the car, using it to power or control console dome lights 112. The dome lights 112 turn on and off with the dome light(s) in the car's passenger compartment. In some installations, however, one or more of the car's original dome lights are removed in order to install the overhead console 100; in such installations, the dome lights 112 replace the car's original dome light(s).

The overhead console 100 may also connect to the car's audio system. This arrangement allows the overhead console to play sound through the speakers of the audio system. The console 100 also includes a pair of built-in speakers and one or more headphone jacks.

The base 110 has a docking bay 114 for receiving various portable entertainment devices, such as video players. FIG. 1C is a close-up view of a portion of the docking bay 114 that includes a connector 116 for electrically coupling various portable (or personal) media players (or other portable entertainment devices) to the base of the overhead console 100. The portable media players have complimentary connectors, so that when a player is inserted into the docking bay 114 and slid towards the connector 116, the player's connector plugs into the connector 116 and an electrical connection is established between the portable media player and the console 100. The connector 116 may be an interference fit connector. The connector 116 is located in the docking bay and is designed to receive coupling connectors of various portable media players and other portable entertainment devices.

When inserted into the base 110, the portable media player is locked in position so that it does not fall from the docking bay 114. A release button may be provided on the portable media player, the overhead console 100, or on both of these devices. In some variants, a physical key or a code is required to remove the portable media player from the overhead console 100. They key or code secures the portable media player when the car is entrusted to third parties, for example, for parking or service. In some variants, the portable media player is selectively monitored and secured by the security system installed in the vehicle, as is described in U.S. patent application Ser. No. 11/018,689, entitled SECURITY AND REMOTE ACCESS FOR VEHICULAR ENTERTAINMENT, SAFETY, AND CONVENIENCE SYSTEMS, filed on Jan. 2, 2004. This application is incorporated by reference as if fully set forth herein, including all figures, tables, and claims.

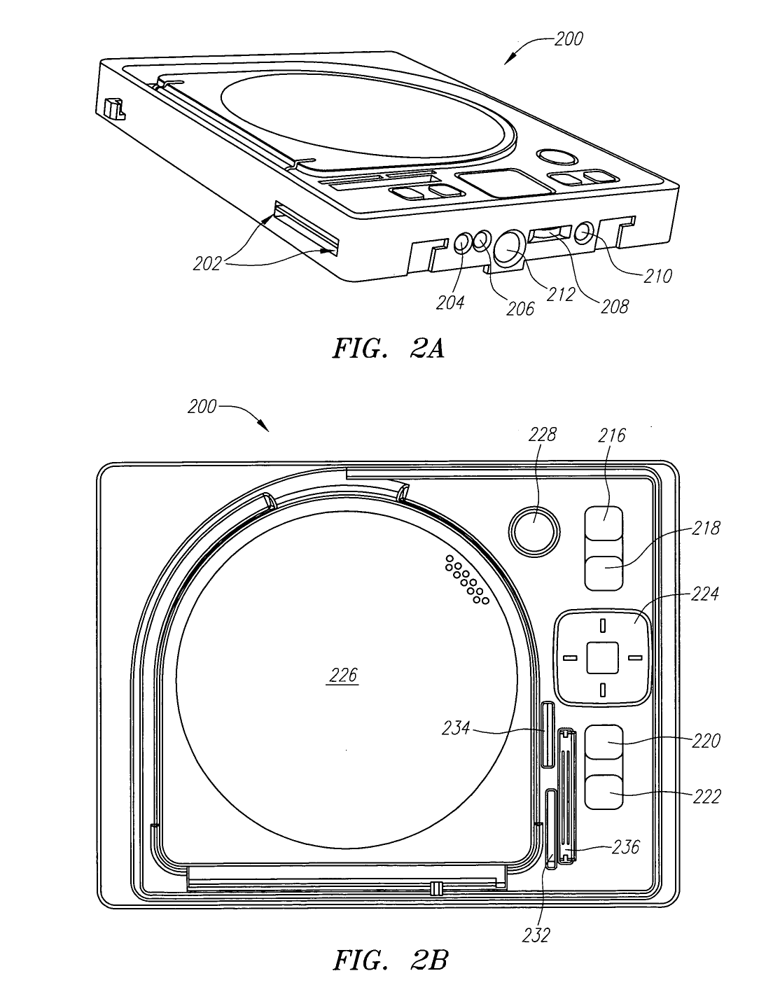

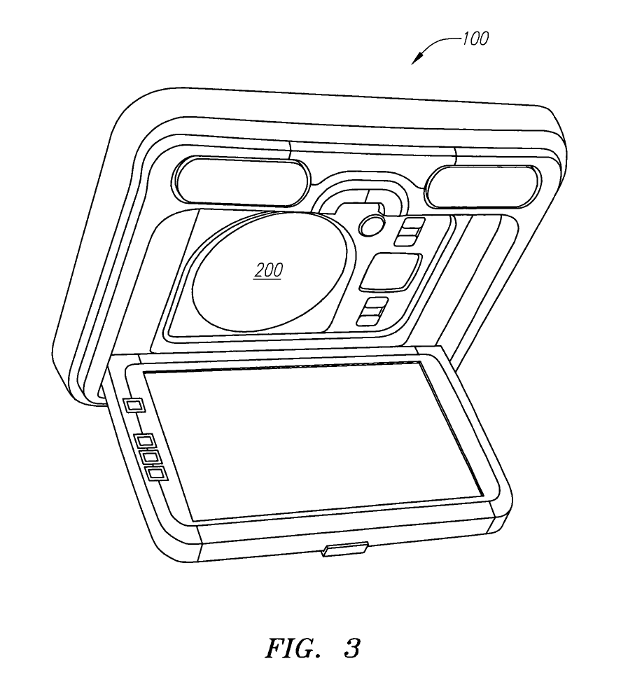

FIGS. 2A and 2B show perspective and top views, respectively, of a portable DVD player 200 that can be inserted into the docking bay 114 and electrically coupled to the overhead console 100. In particular, a player coupling connector 202 of the player 200 plugs into the connector 116 of the overhead console 100. FIG. 3 shows the overhead console 100 in the open position with the DVD player 200 docked in the bay 114. In this position, the DVD player 200 (or another portable entertainment device docked in the bay 114) is powered by the electric system of the car through the overhead console 100, and can be operated to provide video and audio data streams to the overhead console 100. As will be explained in more detail below, the overhead console receives the video and audio data streams from the DVD player 200 (or another portable entertainment device in the bay 114), renders the video on its screen 132, and plays the audio through the plugged-in headphones, built-in speakers, and/or the speakers of the car's audio system.

The DVD player 200 is an autonomous portable entertainment device capable of playing DVD media by itself or through another device. The player 200 includes a power supply, such as a rechargeable battery with charging circuitry and power supply adaptor, screen, audio drivers/speakers, DVD drive, and electronic circuitry for reading video and audio data from DVDs and driving the screen and the speakers with the audio streams generated from the data. When the DVD player 200 is docked in the bay 114, it receives (through the coupling connector 202) electrical power from the overhead console 100 for its operation and, if needed, for charging its internal battery. The DVD player 200 can be configured to turn off its integral screen and speakers/audio drivers when docked in and playing through the overhead console 100. Typically, the screen of the overhead console is larger than the screen of the portable media players designed for docking in the bay 114. Thus, the viewing experience is enhanced by playing the video through the overhead console 100, rather than on the screen of the portable media player. Similarly, the audio playback is enhanced by listening through the overhead console 100. Toward these ends, the DVD player 200 uses the connector 202 to send video and audio streams to the console 100. Additionally, two wired jacks 204 and 206 are provided for outputting DVD audio to headphones. The level of the audio output through the jacks 204 and 206 is controlled by a volume control wheel 208.

As noted above, the DVD player 200 is capable of independent operation using its internal battery. Moreover, the DVD player 200 can be connected to a TV set or a home theater system. Video and audio from the player 200 can be received through an A/V connector 210 or an S-port connector 212. Operation of the DVD player 200 is controlled using an AUDIO key 216, MENU key 218, PLAY/PAUSE key 220, STOP key 222, and navigation/scrolling key 224. A DVD cover 226 is opened by depressing an OPEN button 228. The capability to operate the DVD player 200 independently allows the user of the overhead console 100 to remove the player 200 from the console 100 after arriving at a destination, and to continue watching a presentation after leaving the car.

It should be noted that in some variants the operation of the DVD player 200 may also be controlled through the console 100. For example, user controls of the console 100 may cause control signals to be sent from the console 100 to the DVD player 200, causing the DVD player 200 to start, stop, and pause playback, as well as perform other menu functions.

Another feature of the DVD player 200 worthy of attention is its ability to play video and audio from Flash media. Note three memory reader cards 232/234/236 on top of the player 200. In this embodiment, the slots accept CompactFlash® (232), Memory Stick® (234), and Secure Digital® (236) memory cards. The player 200 has a card reader capable of reading data from each of these card types; the processor of the player 200 then converts the read data into audio and video streams that can be played back on the player 200, or sent out to the overhead console 100 (via the coupling connector 202), headphones (via the jacks 204/206), or TV set or home theater system (via the A/V connector 210 or the S-port connector 212).

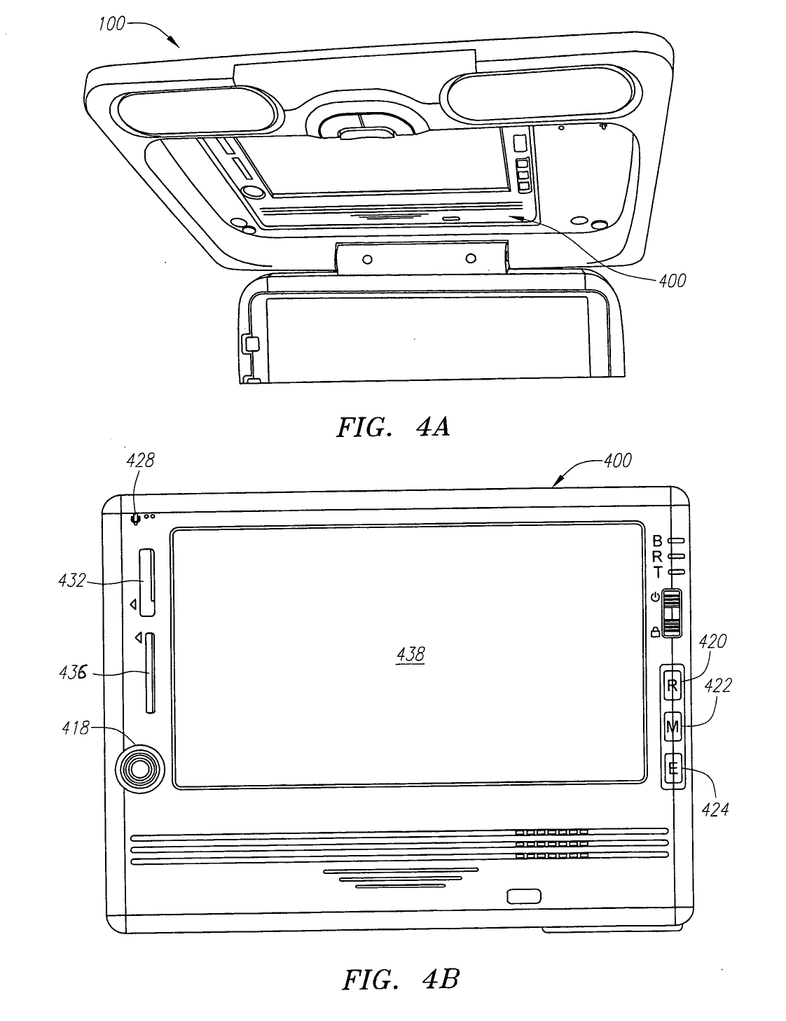

FIG. 4A shows a hard drive (HD) based video player 400 inserted and locked in the docking bay 114 of the overhead console 100 and electrically coupled to it in the same manner as is described above in relation to the DVD player 200. In other words, the HD video player 400 receives electrical power through the console 100, and sends video and audio streams for playback using the screen and audio drivers of the console 100. FIG. 4B is a top view of the HD player 400.

The HD player 400 has two memory card slots: (1) CompactFlash® slot 434, and (2) Secure Digital® slot (436). As in the case of the DVD player 200, the HD player 400 has a card reader capable of reading data from each of these card types, and a processor that converts the read data into audio and video streams, which can be played back on the HD player 400, or sent out to the overhead console 100, headphones, or TV set or home theater system. Of course, the player 400 can also itself play video and audio presentations stored on its internal hard drive.

The player 400 further includes a 5-way navigation key 418, record key 420 for recording on the internal hard drive, menu key 422, exit key 424, infra-red receiver window 426 (for remote control and possibly other functions), and a microphone opening 428 (for recording live sound).

Note that the player 400 is also a recorder: it can accept video and audio streams and record them on the internal hard drive for later playback, for example, playback through the overhead console 100, TV set or home theater system, or using its integral display 438 and built-in audio drivers/speakers.

It should be understood that other portable entertainment devices can be inserted into the docking bay 114 and played through the overhead console 100 in a similar fashion. Such “dockable” devices may include CD players, TV tuners, conventional radio (AM/FM) receivers, satellite receivers (radio and TV), and other devices.

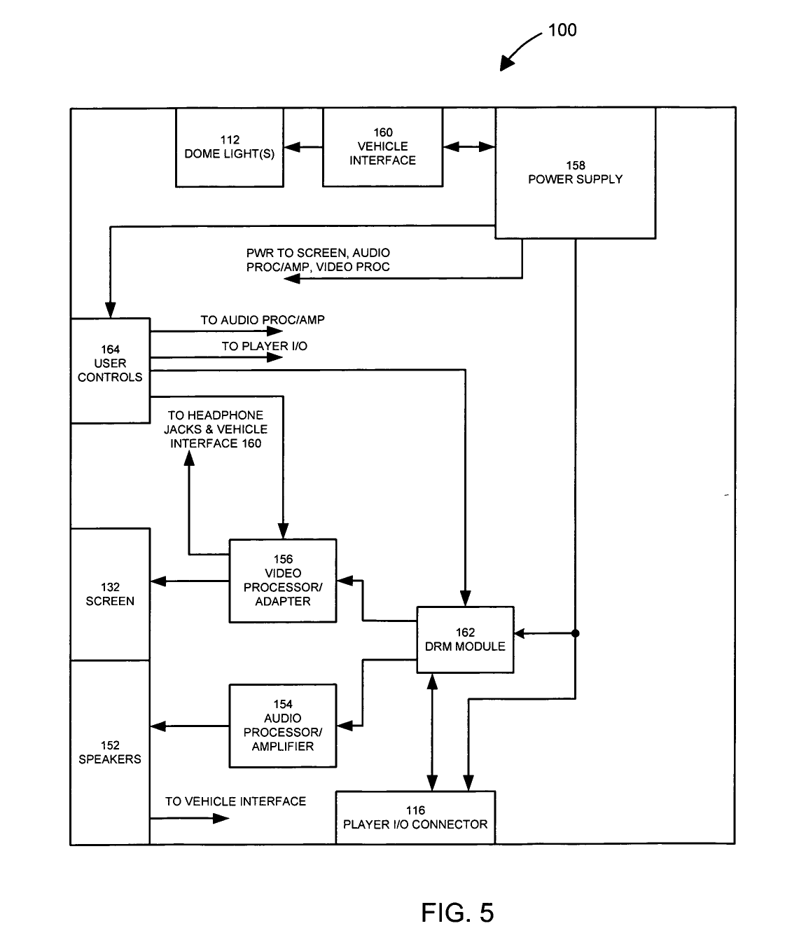

FIG. 5 is a high-level electrical block diagram of an embodiment of the overhead console 100. This embodiment includes ten components depicted in the Figure, several of which have already been discussed.

A vehicle interface 160 is a connector for coupling the overhead console 100 to the car in which it is installed. It may include a power connection for receiving electrical power from the car's power system, a dome light power connection for powering or controlling the dome lights 112, and a connection to the car's speakers (i.e., the speaker's of the car's audio system), so that the audio from the docked portable entertainment device can be played through the car's speakers.

The power received from the car's electrical system is routed to a power supply block 158, which conditions it for use by other components of the overhead console 100 and for powering the docked portable entertainment device through the connector 116. For example, the power supply block 158 may filter the received voltage, regulate it, down convert it, and/or up convert it, to match the input power requirements of the docked player and electronics of the console 100.

A video processor/adapter 156 receives video signals (video stream) from the connector 116 and adapts the video signals for rendering on the screen 132.

An audio processor/amplifier 154 receives audio signals from the connector 116 and amplifies the audio signals to drive speakers 152, headphones, or the speakers of the car's audio system. In some variants, the audio processor/amplifier 154 performs digital-to-analog conversion of the digital audio stream into analog signals capable of driving the speakers or headphones.

The digital rights management (DRM) module 162 controls (restricts) the use of the content played or copied from the player docked to the console 100 through the connector 116, thereby providing management of intellectual property rights to the content. Depending on the availability of rights to the content, the digital rights management module 162 selectively enables and disables playback of the content, for example, by turning on and off the audio and video playback.

User controls 164 provide a user interface for the overhead console 100. For example, the user controls 164 may include a volume control, on/off switch, alphanumeric keypad, and other controls. In some variants, a hand-held remote control device and a receiver at the console are provided as part of the user controls 164.

In some embodiments, the overhead console 100 is built on a platform of one or more digital processing devices that perform, in part or in whole, various functions described throughout this specification. The processing devices may include a general purpose processor controlled by program code, and other electronic components supporting operation of the processor, including memories, watchdog timers, interface devices, input/output (I/O) circuits, and other peripheral devices. The processor can be a microprocessor. Under control of the program code, the processor may implement the digital rights management module 162, read the state of the user controls 164, and configure the console 100 in accordance with the state of the user controls 164. For example, the processor may vary the audio volume generated by the audio processor/amplifier 154 responsive to a volume control setting on the user controls 164. The processor may also select appropriate output for the audio from among headphone jack(s), speakers built into the console 100, or speakers of the car's audio system. By way of another example, the processor may receive from the user codes associated with digital rights to content, determine whether rights to a particular item of content are available, and enable or disable playback of the particular item of content depending on availability of the rights.

Note that the overhead console 100 does not include an autonomous power supply capable of providing electrical power for the operation of the console 100 when a media presentation is played. In other embodiments, a console may have an independent source of power, for example, a battery, either primary (non-rechargeable) or secondary (rechargeable). The overhead console 100 also does not include a source of media presentations, such as a CD, DVD, Flash memory reader, or a hard drive. In other embodiments, an overhead console may have such a source built into it. For example, an overhead console may include a built-in Flash memory reader, in addition to a docking bay for personal media players.

With the screen 132 being relatively large, at least when compared to the screens of the portable media players dockable with the console 100, there is typically enough area to play video from two sources at the same time. This allows the car's passengers to watch two different presentations (shows). For example, a portable media player may provide two different sets of video/audio data streams, one video/audio data stream combination per recorded show. The overhead console 100 then separately processes each video/audio data stream set, displaying each video data stream in a different area of the screen 132 (left and right screen halves, for example), or on separate screens of the console. Similarly, each audio stream is output through a different headphone jack. Alternatively, one audio stream may be output through the car's speakers, while the other one is output through a headphone jack.

The multiple video/audio data stream sets may originate from a single portable media player docked to the overhead console 100. For example, the HD player 400 may be capable of simultaneously reading data for two sets of video/audio data streams from its hard drive, and providing the two sets to the overhead console 100 through the coupling connector that plugs into the connector 116. As another example, a dockable portable entertainment device may have two different sources of content, for example, (1) a hard or DVD drive, and (2) a satellite receiver.

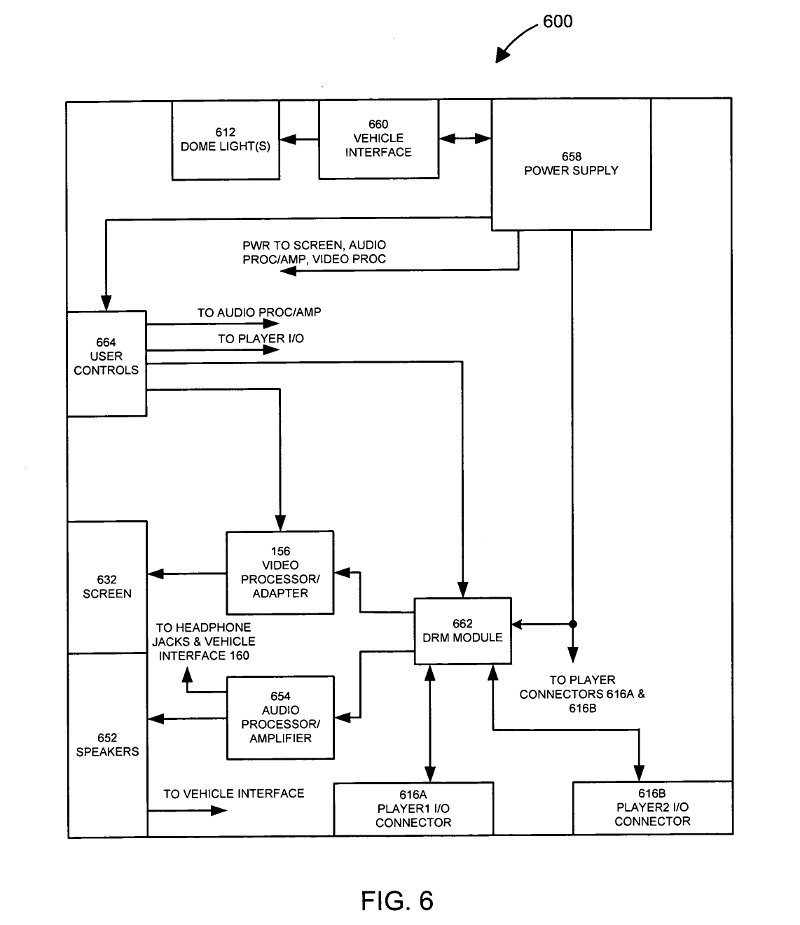

FIG. 6 is a high-level electrical block diagram of a dual-bay embodiment of an overhead console 600. This dual-bay overhead console includes two docking bays, each identical or similar to the docking bay 114 of the overhead console 100. Each docking bay has a connector for electrically coupling various portable media players to the base of the overhead console 600. These connectors, designated with reference numerals 616A and 616B, are similar or identical to the connector 116 shown in FIG. 5. Other components shown in FIG. 6 are also similar or identical to the corresponding components of the console 100 of FIG. 5, but provide additional functionality necessary for simultaneously displaying two video streams and simultaneously generating sound from two different audio streams.

Two portable media players (or other portable entertainment devices) can be docked to the console 600, one player per bay, and played at the same time. The dual-bay console can then receive one set of video/audio data streams from each of the two players, and play corresponding videos simultaneously in different areas of the console's screen. The audio streams would also be processed and outputted to different destinations. For example, sound generated from the different audio streams can be outputted to different headphone jacks. As another example, sound generated from one audio stream can be outputted to one or more headphone jacks, while sound generated from another audio stream can be outputted to the speakers of the car or of the overhead console. Of course, there is no requirement for both players to be docked in order to play content available from one of the players; the player with the content may be docked to the overhead console and played through the console, while the second bay is empty or while the player in the second bay is turned off or otherwise not operating.

The dual-bay overhead console 600 may also be used to transfer content from one portable media player to another, subject to the availability of digital rights to the content, as determined by a digital rights management module 662. The dual-bay overhead console 600 may receive video and audio data streams provided by a player (e.g., a DVD player) docked to a first bay, and route the received video and audio data streams to a player (e.g., a hard drive-based player) docked in a second bay. The player in the second bay can then be programmed to record the audio and video data streams, creating a copy of the content on the second player. The copy can then be stored in the car, instead of the original. Transfer of the content may be accomplished through a digital rights management module, or through a separate connection between the player I/O connectors 616 of the two docking bays.

Each of the docking bays of the dual-bay embodiment may be disposed in a separate recess; alternatively, both docking bays may be disposed in a single recess.

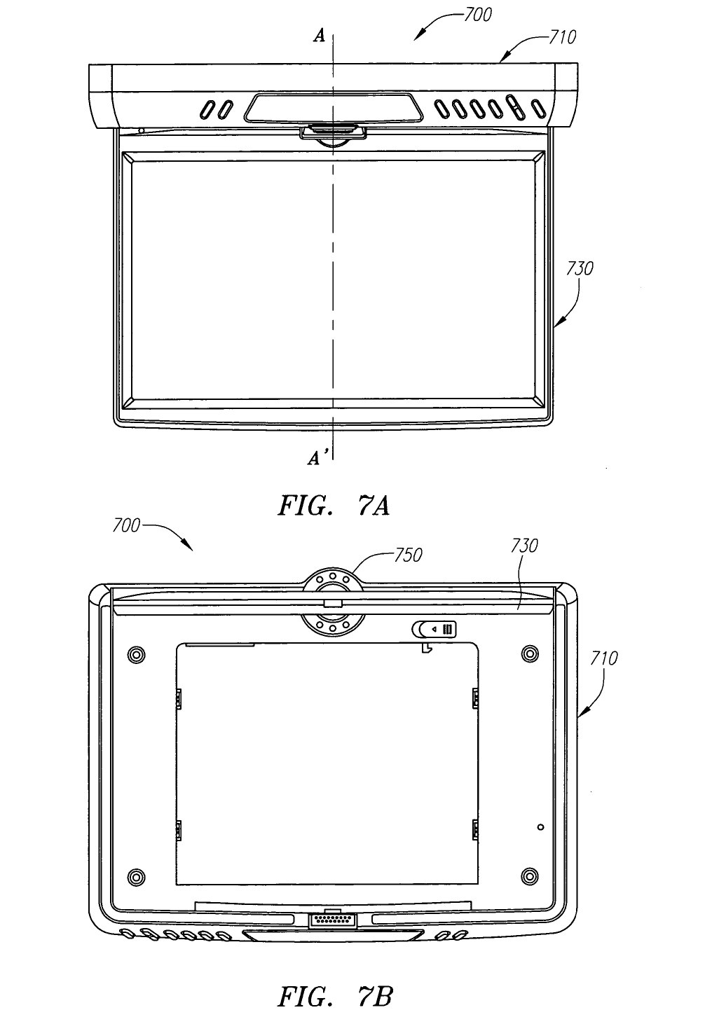

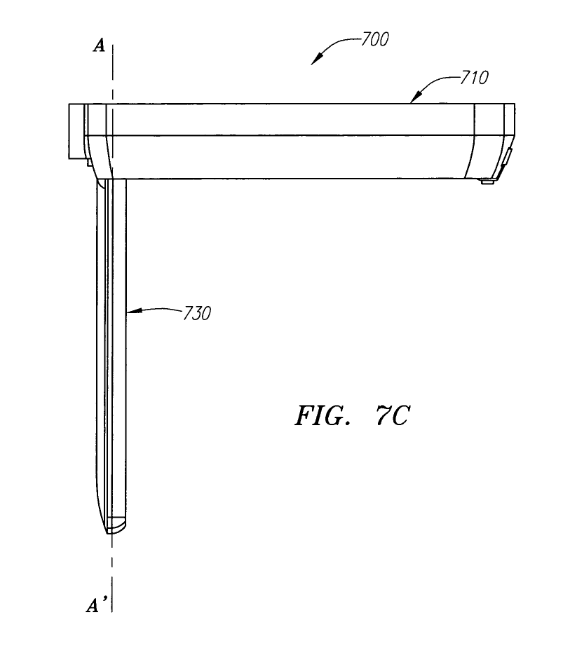

In the overhead console 100 shown in FIGS. 1-5, the screen panel 130 with the screen 132 flips down from the typical installation on the ceiling of a car's passenger compartment. The screen panel 130 may flip down to a predetermined position, to one of several predetermined positions, or the angle between the screen panel 130 and the base 110 may be continuously adjustable between preset limits, generally set between 0 and 180 degrees. In some embodiments, the screen panel can also be rotated around an axis perpendicular to the plane of the base of the console when the screen panel is flipped to a position perpendicular to the base. FIGS. 7A, 7B, and 7C show a console 700 that includes a base 710 and a screen panel 730 joined by a hinged connector 750 that allows the screen panel 730 to rotate around an axis A-A′, which lies in the plane of the panel 730. Note that the axis A-A′ is normal to the axis of tilting (rotation) of the hinged connector 750. FIG. 7A is a front view of the console 700, as the console would be typically installed in a car, with the screen panel 730 in the flipped down position. FIG. 7B is a view of the console 700 looking directly from below the console in this position. FIG. 7C is a side view of the console 700 in the same position.

This document describes in considerable detail the inventive consoles and portable entertainment devices dockable with the consoles, as well as their operation. Such considerable details have been provided for illustration purposes only. Neither the specific embodiments of the invention as a whole, nor those of its features limit the general principles underlying the invention. The specific features described herein may be used in some embodiments, but not in others, without departure from the spirit and scope of the invention as set forth. Various physical arrangements of components and various step sequences also fall within the intended scope of the invention. While three types of storage media have been specifically mentioned (DVDs, Flash memories, and hard drives), the invention extends to the use of other kinds of mass storage media, both permanently writable and rewritable.

Furthermore, portable players used with consoles need not be understood as necessarily or solely being media players; portable players used with the invention may include, without limitation, radio and TV receivers, both terrestrial-based and satellite. In should also be understood that consoles are not necessarily overhead consoles. Consoles may be installed elsewhere, for example, in seat backrests, partitions, and doors. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention, which function is carried out by the claims and their equivalents.

We claim:

1. An entertainment console for mounting in a vehicle, the entertainment console comprising:
a base with portions defining a docking bay configured to receive at least one portable entertainment device;
a console connector disposed in the docking bay, the console connector being configured to couple electrically to a complimentary portable device connector of the at least one portable entertainment device when the at least one portable entertainment device is disposed in the docking bay, wherein, when the console connector is coupled to the complimentary portable device connector, the console connector (1) provides electrical power from the entertainment console to the at least one portable entertainment device, and (2) receives a video data stream from the at least one portable entertainment device; and
a display for rendering video corresponding to the video data stream.

2. An entertainment console according to claim 1, further comprising a video processor wherein the video processor is (1) coupled to the console connector to receive the video data stream, (2) configured to convert the video data stream into video signals corresponding to the video data stream, and (3) coupled to the display to drive the display with the video signals to cause the display to render video corresponding to the video signals.

3. An entertainment console according to claim 2, further comprising a vehicle connection configured to receive electrical power from electrical system of the vehicle.

4. An entertainment console according to claim 3, wherein, when the console connector is coupled to the complimentary portable device connector, the console connector receives at least one audio data stream from the at least one portable entertainment device.

5. An entertainment console according to claim 4, further comprising at least one speaker for reproducing sound corresponding to the at least one audio data stream.

6. An entertainment console according to claim 4, further comprising at least one headphone jack for driving headphones with sound corresponding to the at least one audio data stream.

7. An entertainment console according to claim 4, further comprising an audio processor, wherein the audio processor (1) is coupled to the console connector to receive the at least one audio data stream, (2) is configured to generate sound corresponding to the at least one audio data stream, and (3) is coupled to. audio system of the vehicle to drive speakers of the audio system with the sound corresponding to the at least one audio data stream.

8. An entertainment console according to claim 4, further comprising a digital rights management module restricting rendering on the display of the video corresponding to the video data stream in accordance with intellectual property rights to content corresponding to the video, the rights being available to operator of the entertainment console.

9. An entertainment console according to claim 3, further comprising a dome light and a connector to dome light control of the vehicle, wherein the dome light of the entertainment console is turned on and off in accordance with current state of the dome light control.

10. An entertainment console according to claim 3, wherein the entertainment console does not include an autonomous power supply.

11. An entertainment console according to claim 3, wherein the entertainment console does not include a source of media presentations.

12. An entertainment console according to claim 3, further comprising a hinged connector attaching the display to the base, wherein the hinged connector allows tilting the display with respect to the base.

13. An entertainment console according to claim 12, wherein the hinged connector further allows turning the display around a first axis lying in the plain of the display, the first axis being perpendicular to axis of tilting of the display with respect to the base.

14. An entertainment console according to claim 3, wherein the base comprises a surface configured for mounting the entertainment console on ceiling of the vehicle.

15. A combination of an entertainment console according to claim 4 and a first portable entertainment device docked to the entertainment console, the first portable entertainment device being capable of independent operation when not docked to the entertainment console.

16. A combination according to claim 15, wherein the first portable entertainment device comprises a DVD player.

17. A combination according to claim 15, wherein the first portable entertainment device comprises a DVD player and a Flash memory reader.

18. A combination according to claim 15, wherein the first portable entertainment device comprises a hard drive player.

19. A combination according to claim 15, wherein the first portable entertainment device comprises a hard drive player and a Flash memory reader.

20. A combination according to claim 15, wherein the first portable entertainment device comprises a satellite receiver.

21. A combination according to claim 15, wherein the first portable entertainment device comprises a TV tuner.

22. A portable entertainment device comprising a complimentary connector for docking to the entertainment console of claim 4, wherein the portable entertainment device is (1) capable of independent operation when not docked to the entertainment console, (2) configured to receive power for operation from the entertainment console, and (3) configured to send the video data stream to the entertainment console through the complimentary connector.

23. An entertainment console for mounting in a vehicle, the entertainment console comprising:
a base comprising portions defining a first docking bay configured to receive a first portable entertainment device, the base further comprising portions defining a second docking bay configured to receive a second portable entertainment device;
a first console connector disposed in the first docking bay to couple electrically to a complimentary portable device connector of the first portable entertainment device when the first portable entertainment device is disposed in the first docking bay, wherein, when the first console connector is coupled to the complimentary portable device connector of the first portable entertainment device, the first console connector provides electrical power from the entertainment console to the first portable entertainment device and receives a first video data stream from the first portable entertainment device;
a second console connector disposed in the second docking bay to couple electrically to a complimentary portable device connector of the second portable entertainment device when the second portable entertainment device is disposed in the second docking bay, wherein, when the second console connector is coupled to the complimentary portable device connector of the second portable entertainment device, the second console connector provides electrical power from the entertainment console to the second portable entertainment device and receives a second video data stream from the second portable entertainment device; and
at least one display configured to render first video presentation driven by first video signals generated from the first video data stream, and second video presentation driven by second video signals generated from the second video data stream.

24. An entertainment console according to claim 23, further comprising at least one video processor, wherein the at least one video processor is (1) coupled to the first console connector to receive the first video data stream, (2) configured to generate the first video signals from the first video data stream, (3) coupled to the second console connector to receive the second video data stream, (4) configured to generate the second video signals from the second video data stream, and (5) coupled to the at least one display to drive the at least one display with the first and second video signals to cause the at least one display to render the first video presentation in a first display area, and to render the second video presentation in a second display area, wherein 15 more than half of the first display area does not overlap with the second display area, and more than half of the second display area does not overlap with the first display area.

25. An entertainment console according to claim 24, wherein the at least one video processor is configured to generate the first and second video signals at the same time, whereby the at least one display simultaneously renders the first video presentation and the second video presentation.

26. An entertainment console according to claim 25, further comprising a vehicle connection configured to receive electrical power from electrical system of the vehicle.

27. An entertainment console according to claim 25, wherein, when the first console connector is coupled to the complimentary portable device connector of the first entertainment device, the first console connector receives a first audio data stream from the first portable entertainment device and drives a first sound output device with audio signals corresponding to the first audio data stream, and when the second console connector is coupled to the complimentary portable device connector of the second entertainment device, the second console connector receives a second audio data stream from the second portable entertainment device and drives a second sound output device with audio signals corresponding to the second audio data stream.

28. An entertainment console according to claim 25, wherein:
the at least one display comprises a first screen and a second screen;
the first display area is disposed on the first screen; and
the second display area is disposed on the second screen.

29. An entertainment console according to claim 25, wherein:
the at least one display comprises a first screen;
the first display area is disposed on the first screen; and
the second display area is disposed on the first screen.

30. An entertainment console according to claim 25, further comprising a connection for transferring content from the first portable entertainment device to the second portable entertainment device.

31. An entertainment console according to claim 30, wherein the connection for transferring comprises a digital rights management module.
